(19) United States
(12) Patent Application Publication
(10) Pub. No.: US 2026/0205319 A1
(43) Pub. Date: Jul. 16, 2026

(54) ELECTRONIC APPARATUS AND METHOD FOR OPERATING THE SAME AND STORAGE MEDIUM

(71) Applicant: Samsung Electronics Co., Ltd., Suwon-si (KR)

(72) Inventor: Jeongin KIM, Suwon-si (KR)

(21) Appl. No.: 19/462,365

(22) Filed: Jan. 28, 2026

Related U.S. Application Data
(63) Continuation of application No. PCT/KR2026/001027, filed on Jan. 16, 2026.

(30) Foreign Application Priority Data
Jan. 16, 2025 (KR) 10-2025-0006910

(51) Int. Cl. H04L 12/28

(52) U.S. Cl. CPC H04L 12/2823

(57) ABSTRACT

An electronic apparatus is provided. The electronic apparatus comprises a communication circuit, memory, comprising one or more storage media, storing instructions and at least one processor including processing circuitry communicatively coupled to the communication circuit and the memory, wherein the instructions, when executed by the at least one processor individually or collectively, cause the electronic apparatus to identify at least one device corresponding to a frequency of state changes greater than or equal to a first frequency, based on state information of each of at least one first subscription device that is a target of subscription of state information among a plurality of devices, based on a first device among the identified at least one device not satisfying a first condition, determine subscription state information of the first device to be included in subscription information, and obtain state information of at least one second subscription device that is a target of subscription of state information based on the subscription information corresponding to the determined subscription state information of the first device from an external device through the communication circuit, and wherein the subscription information includes subscription state information corresponding to each of the plurality of devices, and wherein the subscription state information includes information indicating whether the state information of the corresponding device is a target of subscription.

### CROSS-REFERENCE TO RELATED APPLICATION(S)

This application is a continuation application, claiming priority under 35 U.S.C. § 365(c), of an International application No. PCT/KR 2026/001027, filed on Jan. 16, 2026, which is based on and claims the benefit of a Korean patent application number 10-2025-0006910, filed on Jan. 16, 2025, in the Korean Intellectual Property Office, the disclosure of which is incorporated by reference herein in its entirety.

### TECHNICAL FIELD

The disclosure relates to an electronic apparatus and a method for operating the same and a storage medium. More particularly, the disclosure relates to an electronic apparatus for transmitting and receiving data to and from an external device and a method for operating the same and a storage medium.

### BACKGROUND ART

With the development of electronic technology, various types of electronic devices have been developed and distributed, and recently, various methods for efficiently monitoring a plurality of connected devices are being developed.

The above information is presented as background information only to assist with an understanding of the disclosure. No determination has been made, and no assertion is made, as to whether any of the above might be applicable as prior art with regard to the disclosure.

### DISCLOSURE OF INVENTION

### Solution to Problem

Aspects of the disclosure are to address at least the above-mentioned problems and/or disadvantages and to provide at least the advantages described below. Accordingly, an aspect of the disclosure is to provide an electronic apparatus for transmitting and receiving data to and from an external device and a method for operating the same and a storage medium.

Additional aspects will be set forth in part in the description which follows and, in part, will be apparent from the description, or may be learned by practice of the presented embodiments.

In accordance with an aspect of the disclosure, an electronic apparatus is provided. The electronic apparatus comprises a communication circuit, memory, comprising one or more storage media, storing instructions and at least one processor including processing circuitry communicatively coupled to the communication circuit and the memory, wherein the instructions, when executed by the at least one processor individually or collectively, cause the electronic apparatus to identify at least one device corresponding to a frequency of state changes greater than or equal to a first frequency, based on state information of each of at least one first subscription device that is a target of subscription of state information among a plurality of devices, based on a first device among the identified at least one device not satisfying a first condition, determine subscription state information of the first device to be included in subscription information, and obtain state information of at least one second subscription device that is a target of subscription of state information based on the subscription information corresponding to the determined subscription state information of the first device from an external device through the communication circuit, and wherein the subscription information includes subscription state information corresponding to each of the plurality of devices, and wherein the subscription state information includes information indicating whether the state information of the corresponding device is a target of subscription.

In accordance with another aspect of the disclosure, a method for operating an electronic apparatus is provided. The method includes identifying at least one device corresponding to a frequency of state changes greater than or equal to a first frequency, based on state information of each of at least one first subscription device that is a target of subscription of state information among a plurality of devices, based on a first device among the identified at least one device not satisfying a first condition, determining subscription state information of the first device to be included in subscription information, and obtaining state information of at least one second subscription device that is a target of subscription of state information based on the subscription information corresponding to the determined subscription state information of the first device from an external device through a communication circuit, wherein the subscription information includes subscription state information corresponding to each of the plurality of devices, and wherein the subscription state information includes information indicating whether the state information of the corresponding device is a target of subscription.

In accordance with another aspect of the disclosure, one or more non-transitory computer-readable storage media storing one or more computer programs including computer-executable instructions that, when executed by at least one processor of an electronic apparatus individually or collectively, cause the electronic apparatus to perform operations are provided. The operations include identifying at least one device corresponding to a frequency of state changes greater than or equal to a first frequency, based on state information of each of at least one first subscription device that is a target of subscription of state information among a plurality of devices, based on a first device among the identified at least one device not satisfying a first condition, determining subscription state information of the first device to be included in subscription information, and obtaining state information of at least one second subscription device that is a target of subscription of state information based on the subscription information corresponding to the determined subscription state information of the first device from an external device through a communication circuit, wherein the subscription information includes subscription state information corresponding to each of the plurality of devices, and wherein the subscription state information includes information indicating whether the state information of the corresponding device is a target of subscription.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram schematically illustrating an electronic apparatus according to an embodiment of the disclosure;

FIG. 2 is a block diagram illustrating a configuration of the electronic apparatus according to an embodiment of the disclosure;

FIG. 3A is a diagram illustrating a method for providing device state information according to an embodiment of the disclosure;

FIG. 3B is a diagram illustrating a method for providing device state information according to an embodiment of the disclosure;

FIG. 4 is a block diagram illustrating a method for transmitting and receiving data between the electronic apparatus and an external device according to an embodiment of the disclosure;

FIG. 5A is a diagram illustrating a device list according to an embodiment of the disclosure;

FIG. 5B is a diagram illustrating a device list according to an embodiment of the disclosure;

FIG. 6 is a flowchart illustrating a method for operating an electronic apparatus according to an embodiment of the disclosure;

FIG. 7 is a flowchart illustrating a method for updating subscription information according to an embodiment of the disclosure;

FIG. 8A is a flowchart illustrating a method for identifying a second buffer region according to an embodiment of the disclosure;

FIG. 8B is a diagram illustrating a method for receiving state information according to an embodiment of the disclosure;

FIG. 9 is a diagram illustrating a method for obtaining device state information based on predetermined subscription information according to an embodiment of the disclosure;

FIG. 10A is a flowchart illustrating a method for obtaining device information according to an embodiment of the disclosure;

FIG. 10B is a diagram illustrating a method for obtaining device information and history information from an external device according to an embodiment of the disclosure;

FIG. 11 is a flowchart illustrating a method for identifying subscription information based on activation of an application according to an embodiment of the disclosure;

FIG. 12 is a diagram illustrating a method for obtaining device information according to an embodiment of the disclosure; and

FIG. 13 is a block diagram illustrating a specific configuration of an electronic apparatus according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms used in the specification will be briefly described, and the disclosure will then be described.

General terms currently widely used are selected as terms used in embodiments of the disclosure based on their functions in the disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in corresponding descriptions of the disclosure. Therefore, the terms used in the disclosure need to be defined based on the meanings of the terms and the contents throughout the disclosure rather than simple names of the terms.

In the specification, the expression, such as “have”, “may have”, “include”, or “may include”, indicates the presence of a corresponding feature (e.g., a numerical value, a function, an operation, or a component, such as a part), and does not exclude the presence of an additional feature.

An expression, such as “at least one of A or/and B” may indicate either “A or B”, or “both of A and B.”

Expressions, such as “first” and “second”, used in the disclosure may indicate various components regardless of the sequence or importance of the components. The expression is used only to distinguish one component from another component, and does not limit the corresponding component.

If any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the disclosure, a “module” or a “~er/~or” may perform at least one function or operation, and be implemented by hardware, software, or a combination of hardware and software. In addition, a plurality of “modules” or a plurality of “~ers/~ors” may be integrated in at least one module and be implemented by the processor (not shown) except for a “module” or a “~er/or” that needs to be implemented by a specific hardware.

In addition, in the specification, a term, such as “signal” may include not only an electrical signal but also a signal in the form of a sound wave, and the electrical signal may be an analog signal as well a digital signal. For example, an expression, such as “audio signal (or noise signal)” indicates a sound wave (or radio wave) signal if the signal is outside the electronic apparatus, and indicates the electrical signal if the signal is inside the electronic apparatus, depending on its position. In addition, signal processing or the like inside the electronic apparatus described below may be not only digital signal processing but also analog signal processing, or a signal processing method that uses a mixture of analog and digital methods.

In addition, in the specification, a term, such as “filter” indicates a device for removing a specific component (e.g., a specific frequency region or a specific pattern), and the filter may be a digital filter or an analog filter.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

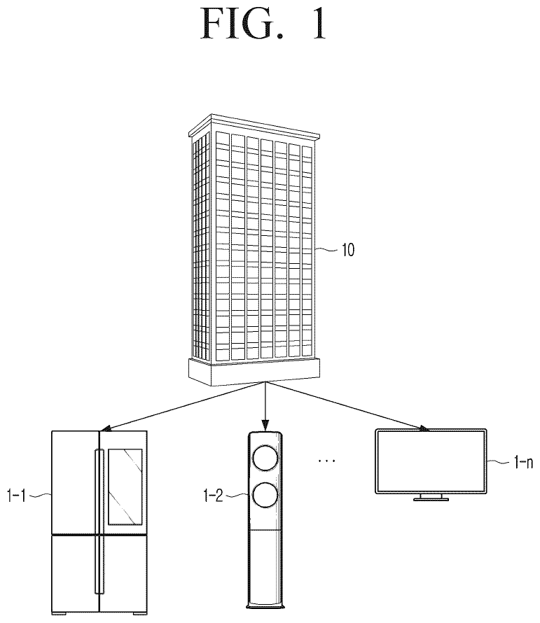

FIG. 1 is a diagram schematically illustrating an electronic apparatus according to an embodiment of the disclosure.

Referring to FIG. 1, the electronic apparatus according to an embodiment of the disclosure may obtain state information of a plurality of devices 1-1, 1-2, . . . 1-n. For example, the plurality of devices may be devices installed in a single building 10, as illustrated in FIG. 1, and are not limited thereto. In an example, the plurality of devices may be a set of devices whose states are monitored in real time through an external device (e.g., a cloud server). In an example, the state information of the device may include the power state, current operation mode, sensor measurements, error code, and the like of the device.

According to an embodiment of the disclosure, the electronic apparatus may identify at least one device having a frequency of state changes greater than or equal to a predetermined value, based on the state information of each of the plurality of devices. In an example, the electronic apparatus may identify a device satisfying a predetermined condition among at least one identified device. In an example, the device satisfying the predetermined condition may be a device whose state information scheduled or relatively likely to be provided to a user.

According to an embodiment of the disclosure, the electronic apparatus may identify subscription information for canceling a subscription to state information of a device not satisfying the predetermined condition. In an example, the subscription information may include information corresponding to whether or not to subscribe to the state information of each of the plurality of devices. In an example, the subscription information may include information on a subscription state (maintained or cancelled), a subscription period, or a range of subscription data for each device.

According to an embodiment of the disclosure, the electronic apparatus may obtain the device state information from an external device through a communication circuit, based on the identified subscription information. In an example, the electronic apparatus may obtain only state information of a device corresponding to a maintained subscription state and provide the state information to the user.

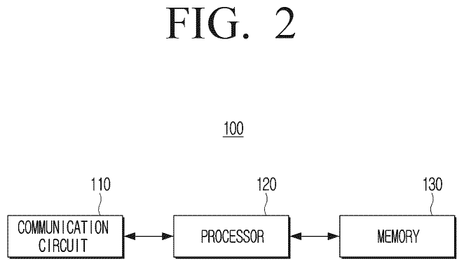

FIG. 2 is a block diagram illustrating a configuration of the electronic apparatus according to an embodiment of the disclosure.

Referring to FIG. 2, the electronic apparatus 100 may include a communication circuit 110, at least one processor 120, and memory 130.

The electronic apparatus 100 may be implemented as a user terminal. In an example, the electronic apparatus 100 may be implemented as any of various types of user terminals, such as a smartphone, a tablet personal computer (PC), a desktop, a laptop, and a smart television (TV), and is not limited thereto.

The communication circuit 110 may input and output various types of data. For example, the communication circuit 110 may transmit and receive various types of data with the external device (e.g., a source device), an external storage medium (e.g., universal serial bus (USB) memory), or an external server (e.g., a web hard) by using a communication method, such as access point (AP)-based wireless fidelity (Wi-Fi), wireless local area network (LAN), Bluetooth, Zigbee, wired/wireless local area network (LAN), wide area network (WAN), Ethernet, IEEE 1394, high definition multimedia interface (HDMI), universal serial bus (USB), mobile high-definition link (MHL), audio engineering society/European broadcasting union (AES/EBU) communication, optical communication, or coaxial communication.

In an example, the communication circuit 110 may include a Bluetooth low energy (BLE) module. The BLE refers to a Bluetooth technology capable of transmission and reception of low-power, low-volume data in a 2.4 gigahertz (GHz) frequency band having a range of about 10 m. However, the communication circuit 110 is not limited thereto, and may include a Wi-Fi communication module. For example, the communication circuit 110 may include at least one of the BLE module or the Wi-Fi communication module.

At least one processor 120 (hereinafter, referred to as the processor) may be electrically connected to the communication circuit 110 and the memory 130, and control overall operations of the electronic apparatus 100. The processor 120 may include one or more processors. More particularly, the processor 120 may perform the operations of the electronic apparatus 100 according to various embodiments of the disclosure by executing at least one instruction stored in the memory 130.

According to an embodiment of the disclosure, the processor 120 may be implemented as a digital signal processor (DSP), a microprocessor, a graphics processing unit (GPU), an artificial intelligence (AI) processor, a neural processing unit (NPU), or a time controller (TCON) for processing digital image signals. However, the processor 120 is not limited thereto, and may include or be defined as at least one of a central processing unit (CPU), a micro controller unit (MCU), a micro processing unit (MPU), a controller, an application processor (AP), a communication processor (CP), or an advanced reduced instruction set computer (RISC) machine (ARM) processor. In addition, the processor 120 may be implemented as a system on chip (SoC) or a large scale integration (LSI) having a built-in processing algorithm, or may be implemented as an application specific integrated circuit (ASIC) or a field programmable gate array (FPGA).

The memory 130 may store data necessary for the various embodiments. The memory 130 may be implemented as memory embedded in the electronic apparatus 100, or as memory detachable from the electronic apparatus 100, based on a purpose of data storage. For example, data for driving the electronic apparatus 100 may be stored in the memory embedded in the electronic apparatus 100, and data for expansion functions of the electronic apparatus 100 may be stored in the memory detachable from the electronic apparatus 100.

Meanwhile, the memory embedded in the electronic apparatus 100 may be implemented as at least one of volatile memory (e.g., dynamic random access memory (DRAM), static RAM (SRAM), or synchronous dynamic RAM (SDRAM)), or non-volatile memory (e.g., one time programmable read only memory (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive, or solid state drive (SSD)). In addition, the memory detachable from the electronic apparatus 100 may be implemented as memory card (e.g., compact flash (CF), secure digital (SD), micro secure digital (Micro-SD), mini secure digital (Mini-SD), extreme digital (xD), or multi-media card (MMC)) or as external memory connectable to a universal serial bus (USB) port (e.g., USB memory).

According to an embodiment of the disclosure, the processor 120 may identify at least one device among the plurality of devices.

In an example, the device may be an electronic device that is communication-connected with the external device (e.g., a cloud server), and a device state may be continuously monitored through the external device. For example, the device may be any of various types of building facilities, such as an air conditioning system, lighting, and a refrigeration system, is not limited thereto, and may be a home appliance, such as a refrigerator, a dishwasher, an air conditioner, an air purifier, or a TV.

In an example, the external device may obtain device information including the state information from each of the plurality of devices to monitor the state of each of the plurality of devices. In an example, the device information may include at least one of the device state information or information on energy usage of the device. In an example, the device state information may include the power state, current operation mode, sensor measurements, and error code of the device. For example, the state information of a smart air conditioner may include a power on/off state, a set temperature, a current indoor temperature, an air volume, or the like, and is not limited thereto.

In an example, the processor 120 may obtain the device state information from the external device. In an example, the processor 120 may obtain the state information of at least some of the plurality of devices through the communication circuit 110.

In an example, the processor 120 may identify at least one device having a frequency of state changes equal to or greater than a first frequency, based on the state information of each of the plurality of devices.

In an example, the first frequency may be the number of state changes per hour, an average number of state changes per day, or a predetermined value based on a user input. In an example, the state change may refer to any of various types of changes, such as a device power state change or a device operation mode change. For example, if the first frequency is five times per hour, the processor 120 may identify a device whose state change is five or more times during one hour, based on the state information of each of the plurality of devices. However, the processor 120 is not limited thereto, and may identify a device whose frequency of state changes corresponds to a different frequency.

According to an embodiment of the disclosure, the processor 120 may identify the subscription information. In an example, the subscription information may include information on whether to subscribe to the state information of each of the plurality of devices. In an example, the subscription information may include the information on the subscription state (maintained or cancelled), the subscription period, or the range of subscription data for each device. In an example, the processor 120 may obtain only information of a device corresponding to the maintained subscription state from the external device based on the subscription information. According to an embodiment of the disclosure, a subscription maintained state may refer to a subscribed state of state information. According to an embodiment of the disclosure, a subscription canceled state may refer to a non-subscribed state of state information.

According to an embodiment of the disclosure, subscription information may include a plurality of subscription state information corresponding to each of a plurality of devices. According to an embodiment of the disclosure, each of the plurality of subscription state information may include information indicating whether the state information of a corresponding device is a subscription target.

In an example, the processor 120 may identify subscription information for canceling a subscription to state information of a first device not satisfying a first condition among at least one identified device.

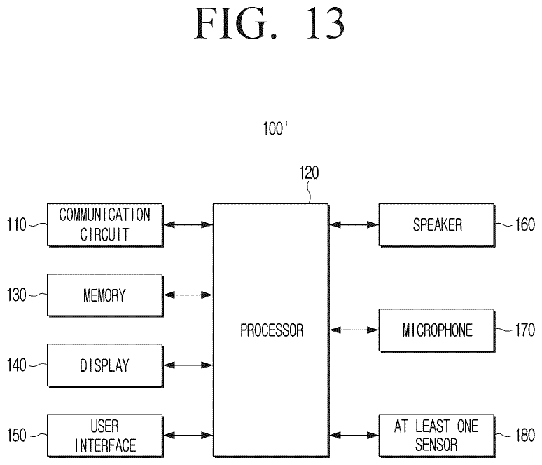

In an example, a device satisfying the first condition may include a device corresponding to a first region displayed on a display (e.g., a display 140 in FIG. 13) among the plurality of devices. For example, the device corresponding to the first region may include a device in a device list that visually provides the state information of each of the plurality of devices and is displayed on the display.

In an example, the device satisfying the first condition may include a device corresponding to a first buffer region adjacent to the first region. In an example, the first buffer region may be a pixel region expanded by a predetermined pixel size, a predetermined ratio, or a predetermined number of devices vertically or horizontally based on the first region in the device list, and is not limited thereto. For example, the number of devices included in the first buffer region may be twice the number of devices included in the first region, and is not limited thereto.

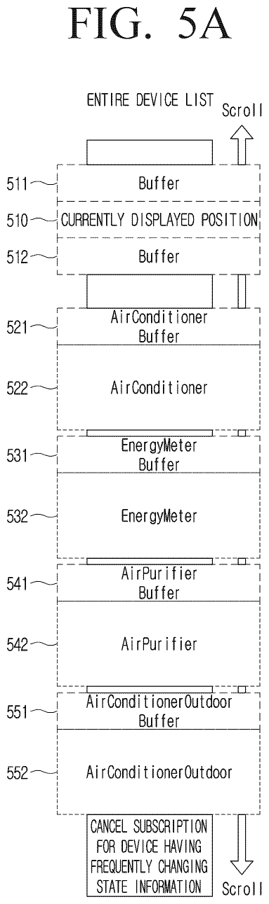

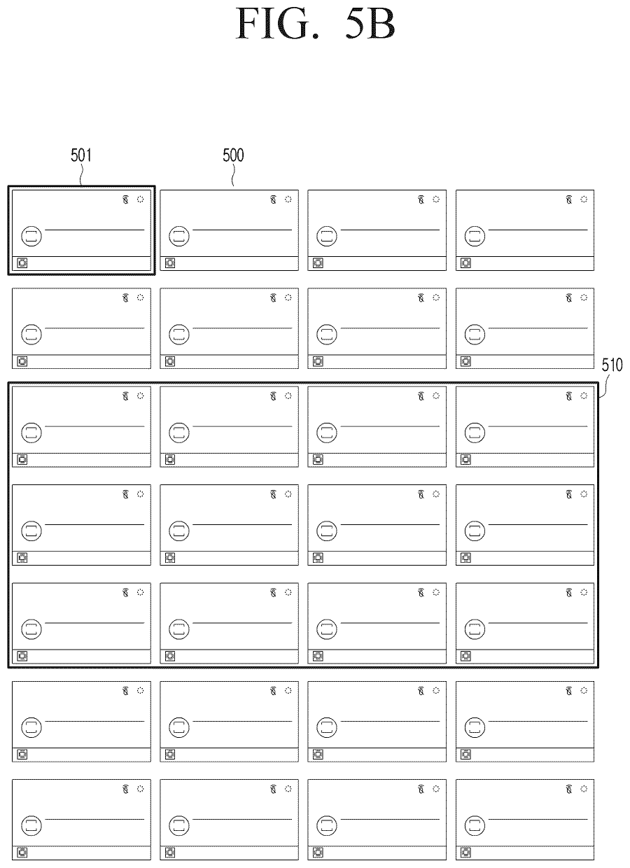

Alternatively, in an example, the device satisfying the first condition may include a device corresponding to a second buffer region corresponding to a device type. In an example, the second buffer region may be a region in the device list that corresponds to a highest-priority device corresponding to each device type (e.g., refrigerator, washing machine, or air conditioner). In an example, the number of devices included in each second buffer region may be twice the number of devices corresponding to the first region, and is not limited thereto. Meanwhile, the device satisfying the first condition is described with reference to FIGS. 5A and 5B.

In an example, the processor 120 may identify the device not satisfying the first condition among at least one identified device. For example, the processor 120 may identify the device satisfying the first condition based on the device list. The processor 120 may identify a first device not satisfying the first condition among at least one identified device.

In an example, if the first device is identified, the processor 120 may identify the subscription information for canceling the subscription to the state information of the first device. In an example, a device corresponding to the canceled subscription may include a case of canceling a subscription to a device currently in the maintained subscription state (or, the subscribed state) and a case of maintaining a canceled subscription to a device currently in the canceled subscription state (or, the non-subscribed state).

According to an embodiment of the disclosure, if the subscription information is identified, the processor 120 may obtain the device state information from the external device through the communication circuit, based on the identified subscription information. In an example, the subscription information may include the information on whether to subscribe to each of the plurality of devices. In an example, the processor 120 may transmit the subscription information to the external device through the communication circuit. The external device may selectively transmit only the state information of the device in the maintained subscription state to the electronic apparatus 100, based on the received subscription information. In an example, the state information transmitted from the external device may be real-time state information of the device currently monitored, and is not limited thereto.

The electronic apparatus 100 may receive the state information of the plurality of devices from the external device, synchronize the device state information, and provide the state information to the user. However, if the number of devices managed by the external device is very large (e.g., 1000 or more), receiving the state information of all devices in real time may cause network traffic.

In the above-described example, the electronic apparatus 100 may preferentially receive the state information of devices that are likely to be displayed to the user, for example, the state information of a device displayed to the user and a device in an adjacent region, or the state information of a device in a region (e.g., the second buffer region) displayed if the user randomly accesses a specific device type.

In addition, the electronic apparatus 100 may reduce the network traffic by canceling a subscription to a device that frequently changes its state, thus frequently updates its state information, thereby causing the network traffic.

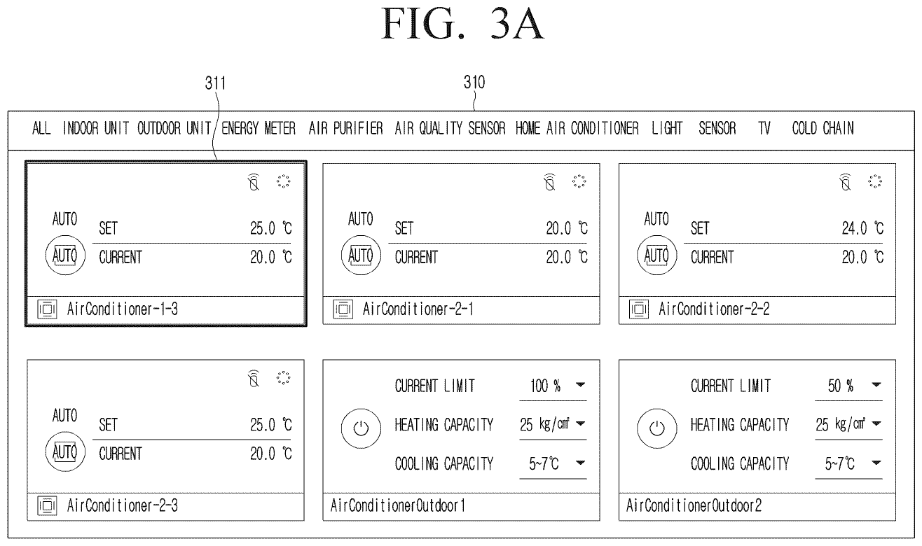

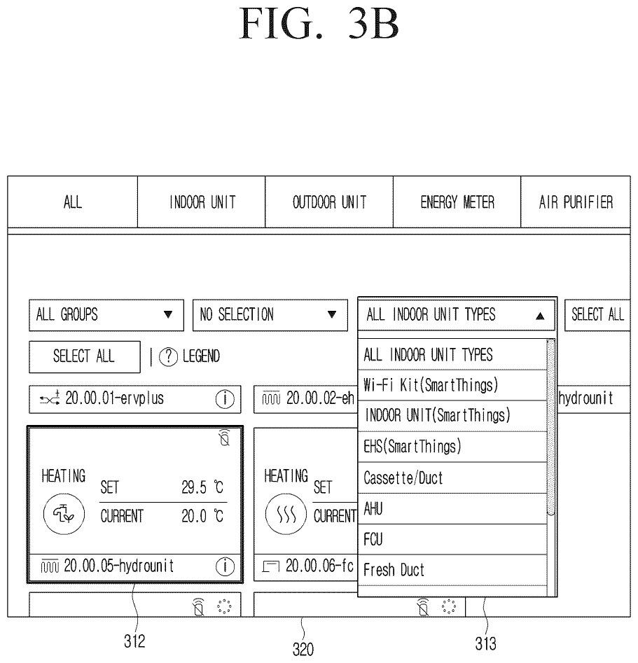

FIGS. 3A and 3B are diagrams illustrating a method for providing the device state information according to various embodiments of the disclosure.

Referring to FIGS. 3A and 3B, according to an embodiment of the disclosure, the electronic apparatus 100 may provide user interfaces (UIs) 310 and 320 each including the device state information. In an example, the electronic apparatus 100 may include a display, and the electronic apparatus 100 may display the UI including the state information on the display.

Referring to FIG. 3A, the electronic apparatus 100 may display the state information of the plurality of devices in a predetermined order. For example, the UI 310 may be a UI that entirely displays a device managed by the external device. The electronic apparatus 100 may display the state information of at least one device on the display based on the device list. In an example, the electronic apparatus 100 may also display state information of a device different from a currently displayed device based on a scroll input from the user. Details of this configuration are described with reference to FIGS. 5A and 5B.

In an example, the device state information may include any of various types of information, such as the operation mode, set value, or current sensing value of the device. For example, device state information 311 of an “air conditioner 1-3” may include information on the operation mode (e.g., an “automatic mode”), set temperature, or current temperature of the current device. Alternatively, for example, device state information 312 of a specific indoor unit type may also include information on the operation mode (e.g., a “heating mode”), set temperature, and current temperature of the current device.

Referring to FIG. 3B, the electronic apparatus 100 may provide only state information of a device of a predetermined type. For example, the electronic apparatus 100 may also provide the UI 320 including only state information of the device of the “indoor unit” type, based on a user input for receiving the device of the “indoor unit” type among a plurality of device types.

In an example, the electronic apparatus 100 may also provide a UI 313 for selection of a sub-device type among the “indoor unit” types. For example, if a user input for selecting a device of an “air handling unit (AHU)” type among the “indoor unit” types is received, the electronic apparatus 100 may also provide state information of the device of the “AHU” type.

As described above, the user may obtain the device state information in a sequential access manner as illustrated in FIG. 3A, or may obtain the device state information in a random access manner as illustrated in FIG. 3B. The electronic apparatus 100 may fixedly obtain the state information of the device corresponding to at least one of the first region or the first buffer region to provide the state information in the sequential access manner, and to this end, the electronic apparatus 100 may identify subscription information in which the device corresponding to the first region or the first buffer region is in the maintained subscription state. Alternatively, the electronic apparatus 100 may identify subscription information in which the device corresponding to the second buffer region is also in the maintained subscription state to provide the device state information in the random access manner.

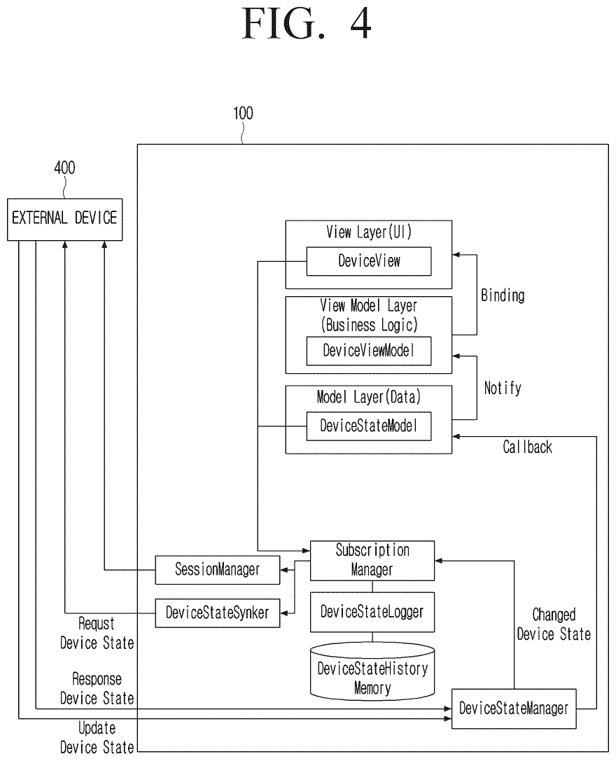

FIG. 4 is a block diagram illustrating a method for transmitting and receiving data between the electronic apparatus and the external device according to an embodiment of the disclosure.

Referring to FIG. 4, according to an embodiment of the disclosure, the electronic apparatus 100 may transmit and receive data to and from the external device 400 through the communication circuit.

In an example, the electronic apparatus 100 may include a “Subscription Manager” module for managing the subscription information. In an example, the “Subscription Manager” module may obtain at least one of information on the device corresponding to the first region or the device corresponding to the first buffer region, which is currently provided on the display, from a “View Layer (UI)” module. Alternatively, the “Subscription Manager” may obtain the information on the device corresponding to the first buffer region based on the device corresponding to the first region.

In an example, although not illustrated in FIG. 4, the electronic apparatus 100 may obtain information on the device corresponding to the second buffer region. For example, a “Subscription Manager” module may obtain the information on the device corresponding to the second buffer region from a “Device State Manager” module or a “Device state History Memory” module. In an example, the “Device state History Memory” module may be a memory storing history information related to the state information. In an example, the electronic apparatus 100 may include a “Device State Logger” module. In an example, the “Device State Logger” module may record the device state information in the “Device state History Memory” module. Alternatively, the “Device State Logger” module may also load the history information related to the device state information from the “Device state History Memory” module.

In an example, the electronic apparatus 100 may obtain information on a device in which the state change occurs from the “Device State Manager” module. In an example, the “Device State Manager” may be a module for managing and controlling the device state. In an example, if the device state information (state information of the device in the maintained subscription state) is obtained from the external device 400, the “Device State Manager” module may transmit information on the device in which the state change occurs based on the obtained state information.

In an example, the electronic apparatus 100 may identify the subscription information. In an example, the “Subscription Manager” module may identify the device having a frequency of state changes greater than or equal to the first frequency, based on the information on the device in which the state change occurs. The “Subscription Manager” module may identify the first device not satisfying the first condition among the identified devices, based on the information of the device corresponding to the first region, the device corresponding to the first buffer region, and the device corresponding to the second buffer region, and may identify the subscription information for making the first device be in the canceled subscription state.

In an example, the electronic apparatus 100 may transmit the identified subscription information to the external device 400. In an example, the electronic apparatus 100 may include a “Session Manager” module. The “Session Manager” module may be a module for transmitting the subscription information related to the device state change to the external device 400. In an example, if the “Session Manager” receives the subscription information from the “Subscription Manager” module, the “Session Manager” may transmit the received subscription information to the external device 400.

In an example, the electronic apparatus 100 may transmit a request signal for the state information to the external device 400. In an example, the electronic apparatus 100 may include a “Device State Synker” module. The “Device State Synker” module may be a module for synchronizing the device state information. The “Device State Synker” module may transmit the request signal for the state information that is obtained from the “Subscription Manager” module to the external device 400.

In an example, the external device 400 may transmit the state information of the device corresponding to the subscription state to the electronic apparatus 100 based on the obtained subscription information. For example, if the subscription information is updated, the external device 400 may transmit the state information corresponding to the updated subscription information to the electronic apparatus 100. In an example, the external device 400 may also transmit a response signal to the request signal for the state information together with the state information to the electronic apparatus 100. In an example, the electronic apparatus 100 may obtain the state information and the response signal from the “Device State Manager” module.

In an example, the “View Layer (UI)” module may transmit the information on the device corresponding to the first region (e.g., the device list) to the “Subscription Manager” module. In an example, the “View Layer (UI)” module may include a “device view” module. The “device view” module may be a component responsible for a user interface and may serve to visually display the device state.

In an example, the electronic apparatus 100 may include a “view model layer (business logic).” The “view model layer (business logic)” may include the “device view” model. The “device view model” may be a component for processing the business logic. In an example, if the “view model layer (business logic)” receives information (e.g., notification information related to the device state) from a “model layer (data logic)”, the “view model layer (business logic)” may bind the received information and transmit the same to the “View Layer (UI)” module.

FIGS. 5A and 5B are diagrams illustrating the device list according to various embodiments of the disclosure.

FIG. 5A is a diagram schematically illustrating the device list according to an embodiment of the disclosure, and FIG. 5B is a diagram illustrating the device list including the device state information according to an embodiment of the disclosure. In an example, referring to FIG. 5B, the device list may be a list of information of the plurality of devices including the device state information. For example, the device list may include the state information of each of the plurality of devices by including device state information 501 disposed at an upper left of FIG. 5B. In an example, a region (or a first region 510) currently displayed on the display may include a predetermined number of device state information.

Referring to FIG. 5A, a first buffer region 511 or 512 may be a region located at a position adjacent to the first region 510. However, the disclosure is not limited thereto.

In an example, the second buffer region 521, 531, 541, or 551 may be a region including the highest-priority device corresponding to each of the plurality of device types. For example, in the case of the device of the “air conditioner” type, the second buffer region 521, 531, 541, or 551 may include a predetermined number of devices having a relatively high priority among devices corresponding to the “air conditioner” type. In an example, a device included in the buffer region corresponding to the “air conditioner” type may be a device having a relatively lowest state change or having a relatively high user interest, and is not limited thereto.

In an example, at least one region other than the second buffer region (or a remaining region 522, 532, 542, or 552) among the plurality of device types may also include at least one of the device in the maintained subscription state or the device in the canceled subscription state. For example, the electronic apparatus 100 may identify the subscription state of the device not satisfying the first condition among the devices included in the remaining regions as the canceled subscription state. Alternatively, for example, the electronic apparatus 100 may also identify the device in the maintained subscription state among the devices included in the remaining regions.

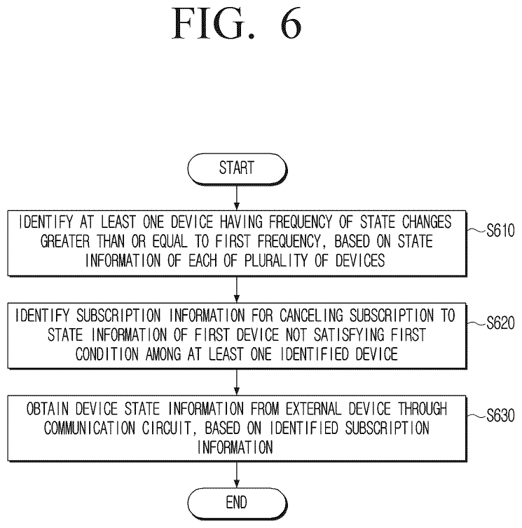

FIG. 6 is a flowchart illustrating a method for operating an electronic apparatus according to an embodiment of the disclosure.

Referring to FIG. 6, according to an embodiment of the disclosure, the operating method may include identifying at least one device having a frequency of state changes greater than or equal to the first frequency, based on the state information of each of the plurality of devices at operation S610.

In an example, the electronic apparatus 100 may obtain the state information of at least some of the plurality of devices. For example, the electronic apparatus 100 may obtain the state information of the device corresponding to the maintained subscription state from the external device through the communication circuit 110.

In an example, the electronic apparatus 100 may identify at least one device having a frequency of state changes greater than or equal to the first frequency, based on the state information of each of the plurality of devices.

According to an embodiment of the disclosure, the operating method may include identifying the subscription information for canceling the subscription to the state information of the first device not satisfying the first condition among at least one identified device at operation S620.

In an example, if at least one device is identified, the electronic apparatus 100 may identify the device satisfying the first condition among at least one identified device. In an example, the electronic apparatus 100 may identify, as the first device, the device not satisfying the first condition among at least one identified device. In an example, if the first device is identified, the electronic apparatus 100 may identify the subscription information for canceling the subscription to the state information of the identified first device.

According to an embodiment of the disclosure, the operating method may include obtaining the device state information from the external device through the communication circuit, based on the identified subscription information at operation S630.

In an example, the electronic apparatus 100 may obtain the device state information from the external device through the communication circuit, based on the identified subscription information. In an example, the electronic apparatus 100 may obtain the state information of the device corresponding to the maintained subscription state from the external device.

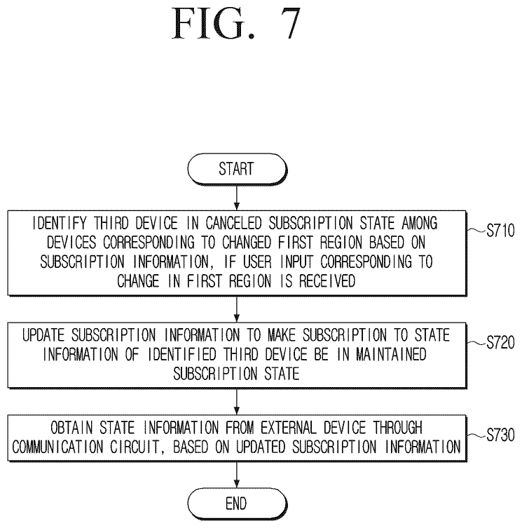

FIG. 7 is a flowchart illustrating a method for updating subscription information according to an embodiment of the disclosure.

Referring to FIG. 7, according to an embodiment of the disclosure, the operating method may include identifying a third device in the canceled subscription state among devices corresponding to a changed first region based on the subscription information, if the user input corresponding to the change in the first region is received at operation S710.

In an example, the user input corresponding to the change in the first region may be the scroll input, and is not limited thereto. In an example, the electronic apparatus 100 may include the user interface, and receive the scroll input through the user interface.

In an example, if the user input corresponding to the change in the first region is received, the electronic apparatus 100 may identify the changed first region. In an example, the electronic apparatus 100 may identify a device corresponding to the changed first region from the device list, based on the user scroll input. In an example, the electronic apparatus 100 may identify the third device in the canceled subscription state among the devices corresponding to the changed first region, based on the subscription information.

According to an embodiment of the disclosure, the operating method may include updating the subscription information to make the subscription to the state information of the identified third device be in the maintained subscription state at operation S720.

In an example, if the third device is identified, the electronic apparatus 100 may update the subscription information to the subscription to the identified third device to be in the maintained subscription state.

According to an embodiment of the disclosure, the operating method may include obtaining the state information from the external device through the communication circuit 110, based on the updated subscription information at operation S730.

In an example, if the subscription information is updated, the electronic apparatus 100 may transmit the updated subscription information to the external device through the communication circuit 110. In an example, the electronic apparatus 100 may receive the state information corresponding to the updated subscription information from the external device.

For example, the electronic apparatus 100 may receive the state information of the third device from the external device. The electronic apparatus 100 may display the state information of the third device on the display.

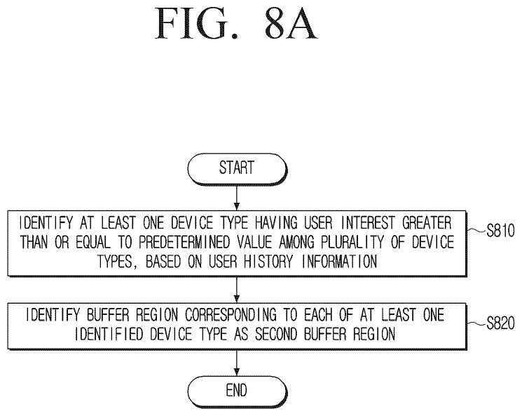

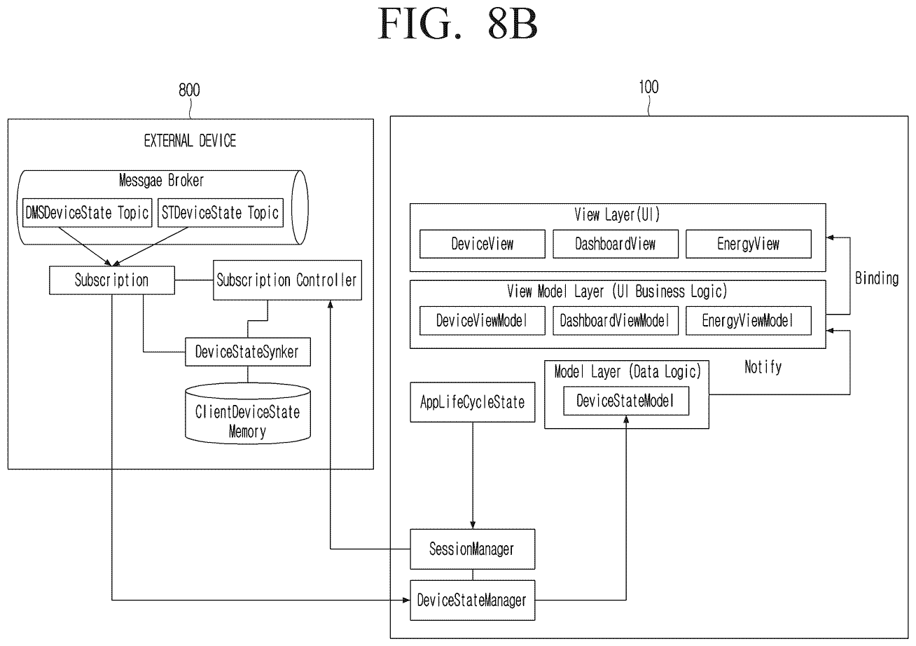

FIG. 8A is a flowchart illustrating a method for identifying the second buffer region according to an embodiment of the disclosure. FIG. 8B is a diagram illustrating a method for receiving the state information according to an embodiment of the disclosure.

Referring to FIG. 8A, according to an embodiment of the disclosure, the operating method may include identifying at least one device type having a user interest greater than or equal to the predetermined value among the plurality of device types, based on user history information at operation S810.

In an example, the electronic apparatus 100 may identify the user interest based on the user history information. In an example, the user history information may include history information related to a device selected by the user (e.g., a selection input from the user for a specific type) or a device monitored by the user. In an example, the user interest may include at least one of the relative selection frequency or monitoring frequency of the user for the specific device type, and is not limited thereto.

In an example, the electronic apparatus 100 may identify at least one device type having the user interest greater than or equal to the predetermined value among the plurality of device types. For example, the electronic apparatus 100 may identify five device types having relatively greatest interest, based on the interest corresponding to each identified type, and is not limited thereto.

According to an embodiment of the disclosure, the operating method may include identifying a buffer region corresponding to each of at least one identified device type as the second buffer region at operation S820.

In an example, the electronic apparatus 100 may identify the buffer region corresponding to each identified device type (or a region including the highest-priority device) as the second buffer region. For example, if five device types are identified, the second buffer region may include five buffer regions (or sub-buffer regions) corresponding to each identified device type.

In an example, the electronic apparatus 100 may identify the device list based on an order of interest. For example, referring to FIG. 5A, a buffer region corresponding to a device type having the relatively highest interest may be located at a lower end of the first buffer region. The electronic apparatus 100 may identify the device list in which the buffer regions corresponding to device types having the relatively lower interest may be located further downward in the device list.

Referring to FIG. 8B, according to an embodiment of the disclosure, the electronic apparatus 100 may receive from an external device 800, information on at least one device having a frequency of state changes greater than or equal to the first frequency.

In an example, an external device 800 may monitor a change in the state of each of the plurality of devices. In an example, the external device 800 may include a “Message Broker” module. In an example, the “Message Broker” module may be a module for receiving real-time state information of the plurality of devices (e.g., devices corresponding to a data management server (DMS) or devices corresponding to SmartThings) and transmitting the real-time state information to a “Subscription” module. In an example, the “Subscription” module may receive the state information from the “Message Broker” module and receive the history information related to the device state information from a “Client Device State History Memory” module through the “Device State Synker” module.

In an example, a “Subscription Controller” module may be a module corresponding to the “Subscription Manager” module in FIG. 4. The “Subscription Controller” module may monitor the state information of the plurality of devices. In an example, the “Subscription Controller” module may identify the device having a frequency of state changes greater than or equal to the first frequency. The “Subscription Controller” module may identify the first device not satisfying the first condition among identified devices, based on the information on the device corresponding to the first region, the device corresponding to the first buffer region, and the device corresponding to the second buffer region, and may identify the subscription information to make the first device be in the canceled subscription state. The “Subscription Controller” module may transmit the identified subscription information to the “Subscription” module, and the “Subscription” module may transmit the state information to the electronic apparatus 100 based on the identified subscription information. In an example, if the device satisfying the first condition is identified among the devices in the canceled subscription state, the “Subscription Controller” module may update the subscription information to make the identified device be in the maintained subscription state.

Alternatively, in an example, the external device 800 may monitor a change in the state of each device, and if the device having a frequency of state changes greater than or equal to the first frequency is identified, the external device 800 may transmit information on the identified device to the electronic apparatus 100. If the information on at least one device having a frequency of state changes greater than or equal to the first frequency is received from the external device 800 through the communication circuit, the electronic apparatus 100 may identify the subscription information for canceling the subscription to the state information of the first device. The electronic apparatus 100 may transmit the identified subscription information to the external device 800 through a “Session Manager” module, and the “Subscription Controller” module included in the external device 800 may update the subscription information based on the received information.

In an example, an “App lifecycle state” module may be a module for managing an execute state of an application. In an example, if the updated state information is received from the external device 800 through the “Device State Manager” module, the “Device State Manager” module may transmit the updated state information to the “model layer.” Through this configuration, the updated state information may be provided to the user on a display.

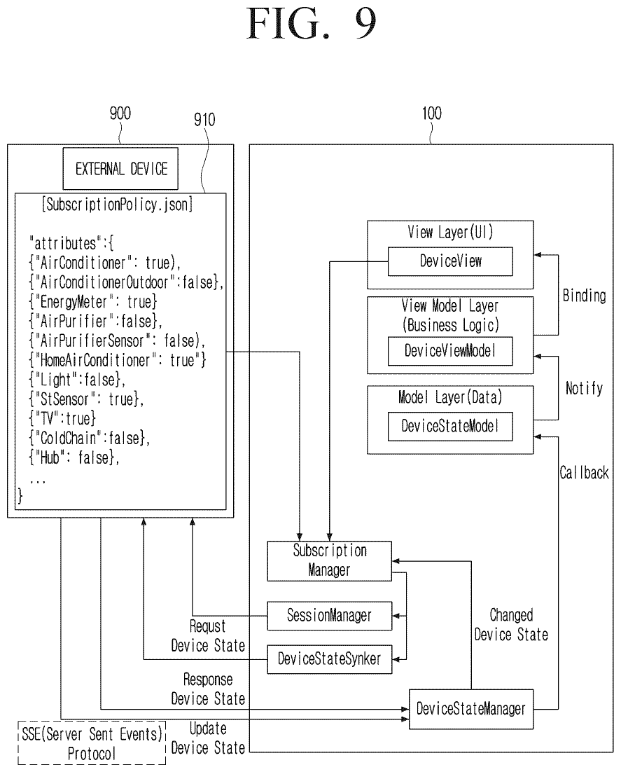

FIG. 9 is a diagram illustrating a method for obtaining the device state information based on predetermined subscription information according to an embodiment of the disclosure.

Referring to FIG. 9, according to an embodiment of the disclosure, the electronic apparatus 100 may obtain predetermined subscription information 910 for each device type from an external device 900. In an example, the predetermined subscription information 910 for each device type may include information on whether to subscribe to each device type. For example, the predetermined subscription information 910 may be obtained from the external device 900 through the communication circuit, the subscription information in which the subscription to a device included in a device type corresponding to the maintained subscription is maintained (e.g., an “air conditioner” type, an “energy meter” type, a “home air conditioner” type, a “silicon (SI) sensor” type, or a “TV” type), and the subscription to a device included in a device type corresponding to the canceled subscription is canceled (e.g., an “air conditioner outdoor” type, an “air purifier sensor” type, a “light” type, a “cold chain” type, or a “hub” type).

In an example, the electronic apparatus 100 may obtain the state information based on the predetermined subscription information 910 for each device type. For example, the electronic apparatus 100 may identify the subscription to the device, excluding the device satisfying the first condition, among the devices corresponding to the canceled subscription type, as being in the canceled subscription state, based on the predetermined subscription information 910 for each device type, and may obtain the state information based thereon.

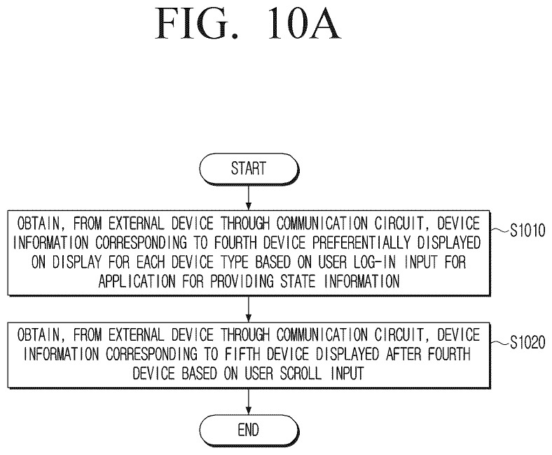

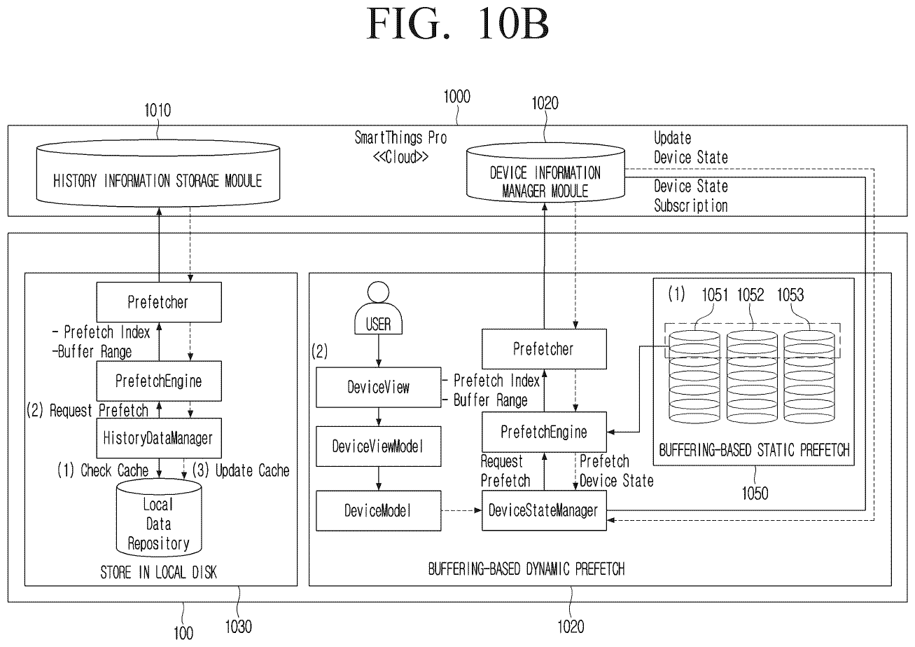

FIG. 10A is a flowchart illustrating a method for obtaining device information according to an embodiment of the disclosure. FIG. 10B is a diagram illustrating a method for obtaining device information and history information from an external device according to an embodiment of the disclosure.

Referring to FIG. 10A, according to an embodiment of the disclosure, the operating method may include obtaining, from an external device 1000 through the communication circuit, device information corresponding to a fourth device preferentially displayed on the display for each device type, based on a user log-in input for an application for providing state information at operation S1010.

In an example, the electronic apparatus 100 may receive the user input. In an example, the electronic apparatus 100 may receive the user log-in input for the application for providing state information. In an example, if the user log-in input is received, the electronic apparatus 100 may obtain the device information corresponding to the fourth device preferentially displayed on the display for each device type, from the external device 1000.

In an example, the device preferentially displayed on the display may refer to a device preferentially provided to the user within a specific device type if the user input for displaying only the specific device type is received. Details of this configuration are described below with reference to FIG. 10B.

In an example, the device information may include at least one of the device state information or the information on energy usage of the device. In an example, the information on energy usage of the device may include at least one of information on energy usage of the device itself for a predetermined time (e.g., one year), information on energy usage of a device included in the type to which the device belongs for a predetermined time, or information on energy usage of a device included in a zone where the device is disposed for a predetermined time, and is not limited thereto. Alternatively, in an example, the device information may also include history information related to notification provision corresponding to the device.

According to an embodiment of the disclosure, the operating method may include obtaining, from the external device 1000 through the communication circuit, device information corresponding to a fifth device displayed after the fourth device, based on the user scroll input at operation S1020.

In an example, the electronic apparatus 100 may receive the user scroll input. For example, the electronic apparatus 100 may receive the user scroll input while executing the application for providing state information.

In an example, if the user scroll input is received, the electronic apparatus 100 may obtain the device information corresponding to the fifth device displayed after the currently displayed fourth device, from the external device 1000 through the communication circuit.

Referring to FIG. 10B, according to an embodiment of the disclosure, the electronic apparatus 100 may obtain the device information corresponding to the fourth device preferentially displayed on the display for each device type, from the external device 1000 through the communication circuit, based on the user log-in input for the application for providing state information.

In an example, if the user log-in input for the application for providing state information is received, the electronic apparatus 100 may obtain the device information corresponding to the fourth device preferentially displayed on the display for each device type, from a device information manager module 1020. In an example, the electronic apparatus 100 may obtain device information corresponding to the device preferentially displayed on the display for each device type among device information 1051, 1052, and 1053 corresponding to the plurality of device types, through a “Prefetch Engine” module. For example, the electronic apparatus 100 may obtain, in parallel, the device information corresponding to the device preferentially displayed on the display among the device information 1051 corresponding to a first device type, the device information 1052 corresponding to a second device type, and the device information 1053 corresponding to a third device type, through the “Prefetch Engine” module. Here, “Prefetcher” refers to an operation of extracting or obtaining part of entire data in advance from the external device 1000.

In an example, a block 1050 including the device information 1051, 1052, and 1053 displayed in a stack form may be a block schematically illustrating device information stored in the device information manager module 1020, and is not limited thereto. In an example, each stack may correspond to a predetermined number of devices (e.g., the number of devices displayed on the display or the buffer range), and is not limited thereto.

In an example, if the user log-in input is received, the electronic apparatus 100 may obtain information only on the device preferentially displayed on the display. Subsequently, if the user scroll input is received, the electronic apparatus 100 may then obtain the device information corresponding to the fifth device displayed after the fourth device, from the external device 1000.

In an example, the electronic apparatus 100 may obtain the device information corresponding to the fifth device through a block 1040 including the “Prefetcher” module, the “Prefetch Engine” module, and the “Device State Manager” module. If the user scroll input is received, the “Device State Manager” module may transmit a request signal for the device information corresponding to the device displayed after the fourth device to the “Prefetch Engine” module. The “Prefetch Engine” module may request transmission of the device information corresponding to the fifth device to the device information manager module 1020 through the “prefetcher” module. For example, the “Prefetch Engine” module may transmit index information corresponding to the fifth device and information on a buffer range to the device information manager module 1020. The device information manager module 1020 may transmit the device information corresponding to the fifth device to the electronic apparatus 100 through the “Prefetcher” module, based on the received information.

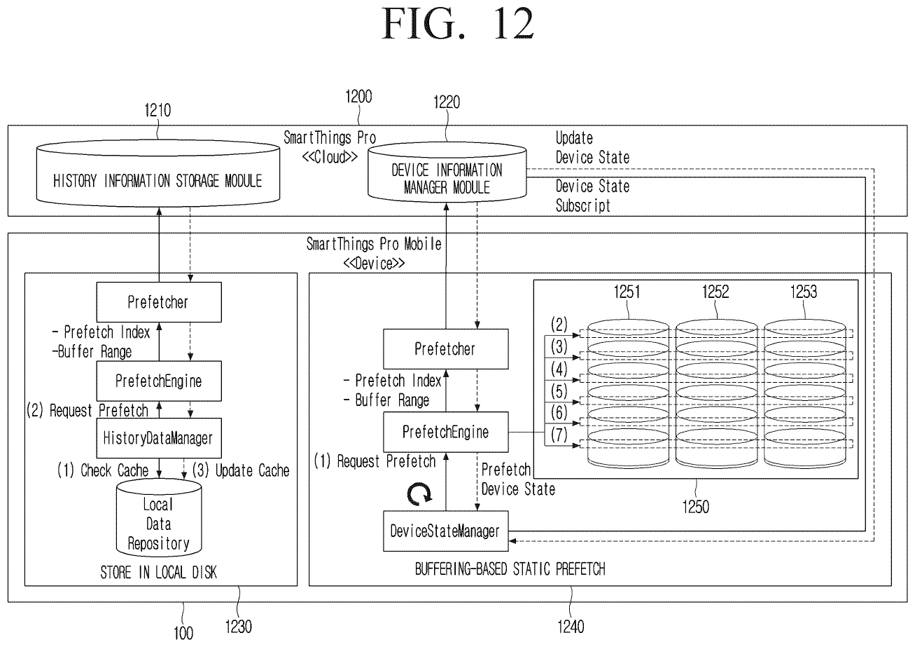

In an example, if additional scroll input is received, the electronic apparatus 100 may obtain device information corresponding to a device displayed after the fifth device. Alternatively, in an example, if the user log-in input or the user scroll input is received, the electronic apparatus 100 may also receive device information corresponding to all devices. Details of this configuration are described with reference to FIG. 12.

In an example, the electronic apparatus 100 may store or update history information related to the device information. For example, referring to a block 1030 illustrated at a lower left of FIG. 10B, a “History Data Manager” module may check a cache of a “Local Data Repository” module storing the history information related to the device information corresponding to each of the plurality of devices, and identify whether the history information needs to be updated. If it is identified that the history information needs to be updated, the “History Data Manager” module may request an update for the history information to the “Prefetch Engine” module. The “Prefetch Engine” module may request transmission of the device information to a history information storage module 1010 storing the history information related to the device information, through the “Prefetcher” module. For example, the “Prefetch Engine” module may transmit index information corresponding to the device information requiring an update and information about a buffer range to the history information storage module 1010.

In the above-described example, the electronic apparatus 100 may preferentially obtain only the device information corresponding to the device preferentially provided to the user and provide the device information to the user, thereby reducing the network traffic. In addition, the electronic apparatus 100 may periodically check whether the device history information needs to be updated, and update the history information at necessary times. The electronic apparatus 100 may update the history information by obtaining only newly added data, thereby reducing the network traffic.

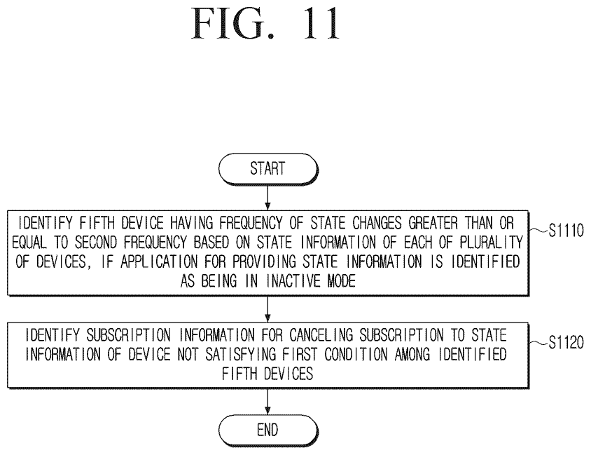

FIG. 11 is a flowchart illustrating a method for identifying the subscription information based on activation of an application according to an embodiment of the disclosure.

Referring to FIG. 11, according to an embodiment of the disclosure, the operating method may include identifying a fifth device having a frequency of state changes greater than or equal to a second frequency based on the state information of each of the plurality of devices, if the application for providing state information is identified as being in an inactive mode at operation S1110.

In an example, the electronic apparatus 100 may identify whether the application for providing state information is in the inactive mode, including a case where the display of the electronic apparatus 100 is in a turned-off state or another application other than the application for providing state information is being executed.

In an example, if the application for providing state information is identified as being in the inactive mode, the electronic apparatus 100 may identify the fifth device having a frequency of state changes greater than or equal to the second frequency based on the state information of each of the plurality of devices. In an example, the fifth device in FIG. 11 may be a device different from the fifth device in FIGS. 10A and 10B.

In an example, the second frequency may be the number of state changes per hour, the average number of state changes per day, or a predetermined value obtained through user input. For example, the second frequency may be a frequency of state changes of a device corresponding to a top 20% among the plurality of devices, and is not limited thereto.

In an example, the electronic apparatus 100 may identify the fifth device whose frequency of state changes greater than or equal to the second frequency based on a period ranging from a time point at which the application is inactivated to a time point at which a predetermined time (e.g., 30 minutes) elapses therefrom.

According to an embodiment of the disclosure, the operating method may include identifying the subscription information for canceling the subscription to the state information of the device not satisfying the first condition among the identified fifth devices at operation S1120.

In an example, the electronic apparatus 100 may identify the subscription information for canceling the subscription to the state information of a remaining device other than the device satisfying the first condition among the identified fifth devices.

In an example, the electronic apparatus 100 may maintain the canceled subscription state of the device having a frequency of state changes greater than or equal to the second frequency until a time point at which the application for providing state information is identified as being in an active mode. For example, the electronic apparatus 100 may periodically monitor the device state change during the inactive mode of the application. The electronic apparatus 100 may periodically identify the device having a frequency of state changes greater than or equal to the second frequency, and update the subscription information based thereon. If the application is switched to the active mode, the electronic apparatus 100 may provide the user with the device state information obtained during the inactive mode based on the updated subscription information.

In the above-described example, if the application is in the inactive mode, the electronic apparatus 100 may reduce the network traffic even during the inactive mode by canceling the subscription for the device having frequent state changes. In this case, by maintaining the subscription to the device satisfying the first condition, the electronic apparatus 100 may immediately provide the device information to the user in both the sequential access situations and the random access situations.

FIG. 12 is a diagram illustrating a method for obtaining the device information according to an embodiment of the disclosure.

Referring to FIG. 12, according to an embodiment of the disclosure, the electronic apparatus may sequentially obtain the device information for each device type in a predetermined data capacity, based on the user log-in input for the application for providing state information.

In an example, if the user log-in input for the application for providing state information is received, the electronic apparatus 100 may obtain the device information for each device type from a device information manager module 1220. In an example, the electronic apparatus 100 may obtain device information 1251, 1252, 1253, and the like corresponding to the plurality of device types through the “Prefetch Engine” module.

In an example, the electronic apparatus 100 may sequentially obtain the device information in the predetermined data capacity (or a predetermined buffer range) through the “Prefetch Engine” module. In an example, a block 1250 including the device information 1251, 1252, and 1253 displayed in a stack form may be a block schematically illustrating device information stored in the device information manager module 1220, and is not limited thereto. In an example, each stack may correspond to a predetermined number of devices (e.g., the number of devices displayed on the display or the buffer range), and is not limited thereto.

For example, the “Prefetch Engine” module may transmit a request signal for device information corresponding to a first stack to the device information manager module 1220 through the “Prefetcher” module. Here, the device information corresponding to the first stack may be information in the predetermined data capacity corresponding to each of the plurality of device types. The “Prefetch Engine” module may obtain, in parallel, device information for each of the plurality of device types as information included in the first stack.

The “Prefetch Engine” module may then transmit a request signal for device information corresponding to a second stack following the first stack to the device information manager module 1220 through the “Prefetcher” module. The device information corresponding to the second stack may be information in the predetermined data capacity for each of the plurality of device types and may be provided after the data corresponding to the first stack is provided.

The “Prefetch Engine” module may request device information until all device information corresponding to each stack is transmitted. If all device information for each of the plurality of device types is completely received, the “Prefetch Engine” module may stop requesting the device information.

In the above-described example, the electronic apparatus may obtain the device information for each of the plurality of device types by dividing the same into the predetermined data capacity. Accordingly, network traffic may be reduced.

In an example, the electronic apparatus 100 may obtain the device information for each of the plurality of device types through a block 1240 including the “Prefetcher” module, the “Prefetch Engine” module, and the “Device State Manager” module. If the user scroll input is received, the “Device State Manager” module may transmit a request signal for the device information to the “Prefetch Engine” module. The “Prefetch Engine” module may request transmission of the device information to the device information manager module 1220 through the “Prefetcher” module. For example, the “Prefetch Engine” module may transmit index information corresponding to the first stack and information about a buffer range to the device information manager module 1220. The device information manager module 1220 may transmit the device information corresponding to the first stack to the electronic apparatus 100 through the “Prefetcher” module, based on the received information.

In an example, the electronic apparatus 100 may store or update the history information related to the device information. For example, referring to a block 1230 illustrated at a lower left of FIG. 12B, the “History Data Manager” module may check the cache of the “Local Data Repository” module storing the history information related to the device information corresponding to each of the plurality of devices, and identify whether the history information needs to be updated. If it is identified that the history information needs to be updated, the “History Data Manager” module may request an update for the history information to the “Prefetch Engine” module. The “Prefetch Engine” module may request transmission of the device information to a history information storage module 1210 storing the history information related to the device information, through the “Prefetcher” module. For example, the “Prefetch Engine” module may transmit index information corresponding to the device information requiring an update and information about a buffer range to the history information storage module 1210.

Returning to FIG. 2, according to an embodiment, the processor 120 may identify a device corresponding to a state change of a first frequency or higher, based on state information of each of at least one first subscription device that is a subscription target of state information among a plurality of devices. According to an example, a subscription device may be a device corresponding to a subscription maintenance state for state information.

According to an embodiment, the processor 120 may determine subscription state information of the first device to be included in subscription information, based on a first device among the identified devices not satisfying a first condition.

According to an example, the processor 120 may identify ‘unsubscribed’ as the subscription state information corresponding to each of the at least one first device. According to an example, the processor 120 may identify subscription information that causes the subscription state of the first device to become ‘unsubscribed’.

For example, when an initial subscription state of the first device is ‘subscribed’, the processor 120 may update the subscription information such that the subscription state of the first device is changed to ‘unsubscribed’. Alternatively, for example, the processor 120 may identify the initial subscription state of the first device as ‘unsubscribed’.

According to an embodiment, the processor 120 may obtain state information of at least one second subscription device that is a subscription target of state information from an external device through the communication circuit, based on subscription information corresponding to the determined subscription state information of the first device. According to an example, the second subscription device may be a device corresponding to a current subscription maintenance state after the subscription state of the first device is changed to ‘unsubscribed’.

FIG. 13 is a block diagram illustrating a specific configuration of an electronic apparatus according to an embodiment of the disclosure.

Referring to FIG. 13, the electronic apparatus 100′ may include the communication circuit 110, at least one processor 120, the memory 130, the display 140, a user interface 150, a speaker 160, a microphone 170, and at least one sensor 180. Detailed descriptions of the components illustrated in FIG. 13 overlapping those illustrated in FIG. 2 are omitted.

The display 140 may be implemented as a display including a self-emitting element or a display including a non-self-emitting element and a backlight. For example, the display 140 may be implemented as various types of displays, such as a liquid crystal display (LCD), an organic light emitting diode (OLED), a light-emitting diode (LED), a micro LED, a mini LED, a plasma display panel (PDP), a quantum dot (QD) display, and a quantum dot light-emitting diode (QLED). The display 140 may further include a driving circuit implemented as an amorphous silicon thin film transistor (a-si TFT), a low temperature poly silicon (LTPS) TFT, or an organic TFT (OTFT), a backlight unit, and the like. Meanwhile, the display 140 may be implemented as a touchscreen to a touch sensor, a flexible display, a rollable display, a three-dimensional (3D) display, or a display in which a plurality of display modules are physically connected each other, or the like. The processor 120 may control the display 140 to output an output image obtained according to the various embodiments described above. Here, the output image may be a high-resolution image of 4K or 8K or higher. The output image may also be a game image according to an embodiment.

According to an embodiment of the disclosure, the display 140 may include a plurality of haptic elements. The haptic element may be implemented as a motor for providing haptic feedback (e.g., vibration feedback) to the user, and is not limited thereto. In an example, the display 140 may include a predetermined number of haptic elements. For example, the display 140 may include a predetermined number of haptic elements corresponding to predetermined sub-regions of the display, and is not limited thereto, and the number of haptic elements included in the display may be different from the number of sub-regions corresponding to the display.

The user interface 150 is a component for the electronic apparatus 100′ to perform interaction with the user. For example, the user interface 150 may include at least one of a touch sensor, a motion sensor, a button, a jog dial, a switch, a microphone, or a speaker, and is not limited thereto.

According to an embodiment of the disclosure, the speaker 160 may include a tweeter for reproducing high-frequency sounds, a midrange for reproducing mid-frequency sounds, a woofer for reproducing low-frequency sounds, a subwoofer for reproducing ultra-low-frequency sounds, an enclosure for controlling resonance, and a crossover network for dividing electric signal frequencies input to the speaker by bands.

According to an embodiment of the disclosure, the speaker 160 may output audio signals to the outside of the electronic apparatus 100′. The speaker 160 may output multimedia playback, recording playback, various alert sounds, voice messages, and the like. The electronic apparatus 100′ may include an audio output device, such as the speaker 160, and may also include an output device, such as an audio output terminal. In particular, the speaker 160 may provide, in a voice form, obtained information, information processed and produced based on the obtained information, a response result to a user voice, an operation result, or the like.

The microphone 170 may refer to a module that obtains sound and converts the sound into an electric signal, and may be a condenser microphone, a ribbon microphone, a moving coil microphone, a piezoelectric microphone, a carbon microphone, or a micro electro mechanical system (MEMS) microphone. In addition, the microphone 170 may be implemented in a method of omnidirectional, bidirectional, unidirectional, subcardioid, supercardioid, or hypercardioid. According to an embodiment of the disclosure, the electronic apparatus 100′ may include the microphone 170 and an inner microphone, and the microphone 170 may be a microphone disposed relatively outside of a body. In an example, the electronic apparatus 100 may obtain an audio signal including external noise through the microphone 170. According to an embodiment of the disclosure, the microphone 170 may be disposed in a direction opposite to a direction in which the speaker 160 emits sound.

At least one sensor 180 (hereinafter, referred to as “sensor”) may include a plurality of sensors of various types. The sensor 180 may measure a physical quantity or detect an operating state of the electronic apparatus 100, and convert measured or detected information into an electric signal. The sensor 180 may include a camera (or a camera sensor), and the camera may include a lens for focusing visible light or other optical signals reflected by and received from an object to an image sensor and the image sensor capable of detecting visible light or other optical signals. Here, the image sensor may include a two-dimensional (2D) pixel array divided into a plurality of pixels. Alternatively, at least one sensor 180 may also include a temperature sensor or an infrared sensor.

In the above-described example, the electronic apparatus 100′ may preferentially receive the state information of the devices that are likely to be displayed to the user, for example, the device displayed to the user and the device in the adjacent region, or the state information of the device in the region (e.g., the second buffer region) displayed if the user randomly accesses the specific device type.

In addition, in the above-described example, the electronic apparatus 100 may reduce the network traffic by canceling the subscriptions for the devices causing the network traffic due to their frequent state changes and frequent updates of the state information.

Meanwhile, according to an embodiment of the disclosure, the various embodiments described above may be implemented by software including an instruction stored in a machine-readable storage medium (e.g., a computer-readable storage medium). The machine may be a device that invokes the stored instruction from a storage medium, may be operated based on the invoked instruction, and may include the display device (e.g., display device A) according to the disclosed embodiments. In case that the instruction is executed by the processor, the processor may directly perform a function corresponding to the instruction, or other components may perform the function corresponding to the instruction under a control of the processor. The instruction may include codes provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored in the storage medium.

In addition, according to one or more embodiments of the disclosure, the method according to the various embodiments described above may be included and provided in a computer program product. The computer program product may be traded as a commodity between a seller and a purchaser. The computer program product may be distributed in a form of the machine-readable storage medium (e.g., compact disc read only memory (CD-ROM)), or may be distributed online through an application store (e.g., PlayStore™). In case of the online distribution, at least a portion of the computer program product may be at least temporarily stored or temporarily generated on a storage medium, such as the memory of a manufacturer server, an application store server, or a relay server.

In addition, each of the components (e.g., modules or programs) according to the various embodiments described above may include a single entity or a plurality of entities, and some of the corresponding sub-components described above may be omitted or other sub-components may be further included in the various embodiments. Alternatively or additionally, some of the components (e.g., the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the of scope and spirit of the disclosure as defined by the appended claims and their equivalents.

What is claimed is:

1. An electronic apparatus comprising:
a communication circuit;
memory, comprising one or more storage media, storing instructions; and
at least one processor including processing circuitry communicatively coupled to the communication circuit and the memory;
wherein the instructions, when executed by the at least one processor individually or collectively, cause the electronic apparatus to:
identify at least one device corresponding to a frequency of state changes greater than or equal to a first frequency, based on state information of each of at least one first subscription device that is a target of subscription of state information among a plurality of devices;
based on a first device among the identified at least one device not satisfying a first condition, determine subscription state information of the first device to be included in subscription information; and
obtain state information of at least one second subscription device that is a target of subscription of state information based on the subscription information corresponding to the determined subscription state information of the first device from an external device through the communication circuit; and
wherein the subscription information includes subscription state information corresponding to each of the plurality of devices, and
wherein the subscription state information includes information indicating whether the state information of the corresponding device is a target of subscription.

2. The electronic apparatus of claim 1, wherein the instructions, when executed by the at least one processor individually or collectively, further cause the electronic apparatus to:
identify the at least one second subscription device based on the subscription information corresponding to the determined subscription state information of the first device; and
transmit, to the external device, a request signal for the state information of the identified at least one second subscription device.

3. The electronic apparatus of claim 1, further comprising:
a display,
wherein the first condition includes a condition corresponding to a first region displayed on the display, corresponding to a first buffer region adjacent to the first region, or corresponding to a second buffer region corresponding to a device type.

4. The electronic apparatus of claim 3, wherein the instructions, when executed by the at least one processor individually or collectively, further cause the electronic apparatus to:
based on the subscription information and a user input corresponding to a change in the first region, identify a third device corresponding to a non-subscription of the state information among devices corresponding to the changed first region;
update the subscription state information corresponding to the third device included in the subscription information to correspond to a subscription; and
obtain the state information of the third device from the external device through the communication circuit, based on the updated subscription information.

5. The electronic apparatus of claim 3, wherein the instructions, when executed by the at least one processor individually or collectively, further cause the electronic apparatus to:
identify at least one device type having a user interest greater than or equal to a predetermined value among a plurality of device types, based on user history information; and
identify a buffer region corresponding to each of the at least one identified device type as the second buffer region.

6. The electronic apparatus of claim 1, wherein the instructions, when executed by the at least one processor individually or collectively, further cause the electronic apparatus to:
transmit the subscription information corresponding to the determined subscription state information of the first device to the external device through the communication circuit; and
obtain state information of the at least one second subscription device, through the communication circuit from the external device.

7. The electronic apparatus of claim 1, wherein the subscription information includes information indicating whether, for each device type, the state information is a target of subscription, and
wherein the instructions, when executed by the at least one processor individually or collectively, further cause the electronic apparatus to obtain state information of a device corresponding to a device type that is a target of subscription of the state information from the external device based on the subscription information.

8. The electronic apparatus of claim 1, further comprising:
a display,
wherein the instructions, when executed by the at least one processor individually or collectively, further cause the electronic apparatus to:
obtain device information corresponding to a fourth device preferentially displayed on the display for each device type, from the external device through the communication circuit, based on a user log-in input for an application for providing state information, and
obtain device information corresponding to a fifth device displayed after the fourth device from the external device through the communication circuit, based on a user scroll input.

9. The electronic apparatus of claim 1, wherein the instructions, when executed by the at least one processor individually or collectively, further cause the electronic apparatus to:
identify a fifth device corresponding to a frequency of state changes greater than or equal to a second frequency, based on the state information of each of the plurality of devices, if an application for providing the state information is identified as being in an inactive mode; and
update the subscription information such that subscription state information of a device not satisfying the first condition among the identified fifth devices corresponds to non-subscription.

10. The electronic apparatus of claim 1, wherein the instructions, when executed by the at least one processor individually or collectively, further cause the electronic apparatus to obtain device information for each device type in a predetermined data capacity, based on a user log-in input for an application for providing state information.

11. A method for operating an electronic apparatus, the method comprising:
identifying at least one device corresponding to a frequency of state changes greater than or equal to a first frequency, based on state information of each of at least one first subscription device that is a target of subscription of state information among a plurality of devices;
based on a first device among the identified at least one device not satisfying a first condition, determining subscription state information of the first device to be included in subscription information; and
obtaining state information of at least one second subscription device that is a target of subscription of state information based on the subscription information corresponding to the determined subscription state information of the first device from an external device through a communication circuit,
wherein the subscription information includes subscription state information corresponding to each of the plurality of devices, and
wherein the subscription state information includes information indicating whether the state information of the corresponding device is a target of subscription.

12. The method of claim 11, further comprising:
identifying the at least one second subscription device based on the subscription information corresponding to the determined subscription state information of the first device; and
transmitting, to the external device, a request signal for the state information of the identified at least one second subscription device.

13. The method of claim 11, wherein the first condition includes a condition corresponding to a first region displayed on a display, corresponding to a first buffer region adjacent to the first region, or corresponding to a second buffer region corresponding to a device type.

14. The method of claim 13, further comprising:
based on the subscription information and a user input corresponding to a change in the first region, identifying a third device corresponding to a non-subscription of the state information among devices corresponding to the changed first region;
updating the subscription state information corresponding to the third device included in the subscription information to correspond to a subscription; and
receiving the state information of the third device from the external device through the communication circuit, based on the updated subscription information.

15. The method of claim 13, further comprising:
identifying at least one device type having a user interest greater than or equal to a predetermined value among a plurality of device types, based on user history information; and
identifying a buffer region corresponding to each of the at least one identified device type as the second buffer region.

16. The method of claim 11, further comprising:
transmitting the subscription information corresponding to the determined subscription state information of the first device to the external device through the communication circuit; and
obtaining state information of the at least one second subscription device, through the communication circuit from the external device.

17. The method of claim 11, wherein the subscription information includes information indicating whether, for each device type, the state information is a target of subscription, and
the method further comprising:
obtaining state information of a device corresponding to a device type that is a target of subscription of the state information from the external device based on the subscription information.

18. The method of claim 11, further comprising:
obtaining device information corresponding to a fourth device preferentially displayed on a display of the electronic apparatus for each device type, from the external device through the communication circuit, based on a user log-in input for an application for providing state information; and
obtaining device information corresponding to a fifth device displayed after the fourth device from the external device through the communication circuit, based on a user scroll input.

19. One or more non-transitory computer-readable storage media storing one or more computer programs including computer-executable instructions that, when executed by at least one processor of an electronic apparatus individually or collectively, cause the electronic apparatus to perform operations, the operations comprising:
identifying at least one device corresponding to a frequency of state changes greater than or equal to a first frequency, based on state information of each of at least one first subscription device that is a target of subscription of state information among a plurality of devices;
based on a first device among the identified at least one device not satisfying a first condition, determining subscription state information of the first device to be included in subscription information; and
obtaining state information of at least one second subscription device that is a target of subscription of state information based on the subscription information corresponding to the determined subscription state information of the first device from an external device through a communication circuit,
wherein the subscription information includes subscription state information corresponding to each of the plurality of devices, and
wherein the subscription state information includes information indicating whether the state information of the corresponding device is a target of subscription.

20. The one or more non-transitory computer-readable storage media of claim 19, the operations further comprising:
identifying the at least one second subscription device based on the subscription information corresponding to the determined subscription state information of the first device; and
transmitting, to the external device, a request signal for the state information of the identified at least one second subscription device.
